(19) United States
(12) Patent Application Publication
(10) Pub. No.: US 2019/0324448 A1
(43) Pub. Date: Oct. 24, 2019

(54) REMOTE STEERING OF AN UNMANNED AERIAL VEHICLE

(71) Applicant: Intel Corporation, Santa Clara, CA (US)

(72) Inventors: Daniel Pohl, Puchheim (DE); Roman Schick, Krailling (DE)

(21) Appl. No.: 16/434,191

(22) Filed: Jun. 7, 2019

(51) Int. Cl. G05D 1/00; G05D 1/10; B64C 39/02; G06K 9/00; H04N 5/232

(52) U.S. Cl. CPC G05D 1/0016; G05D 1/0038; G05D 1/101; B64C 2201/146; G06K 9/0063; H04N 5/23238; B64C 39/024

(57) ABSTRACT

According to various aspects, an unmanned aerial vehicle controlling device may include: a receiver configured to receive a spherical image of a vicinity from an unmanned aerial vehicle; a display configured to display a first person view of the spherical image; a plurality of motion sensors configured to sense a movement within a tracked space; one or more processors configured to map the sensed movement within the tracked space to a mapped movement within the vicinity of the unmanned aerial vehicle and generate a control signal based on the mapped movement; and a transmitter configured to transmit the control signal to the unmanned aerial vehicle.

### TECHNICAL FIELD

Various embodiments relate generally to controlling unmanned aerial vehicles (“UAV”) using a mapped movement of a controlling device in a tracked space.

### BACKGROUND

Steering drones is a difficult task, especially in distant environments. Even experienced pilots may only be good at handling drones within a certain visual distance.

The cost of hiring an experienced pilot to control UAV for inspection tasks can be quite high. Allowing less experienced pilots to control UAV to achieve the same results would be a clear cost benefit for the use of UAV in inspection tasks.

In general, first person view (“FPV”) control of UAV has been used in distant environments. However, FPV only allows for a small field of view of the vicinity of the UAV and does not track movements of the pilot to change the view.

### BRIEF DESCRIPTION OF THE DRAWINGS

Throughout the drawings, it should be noted that like reference numbers are used to depict the same or similar elements, features, and structures. The drawings are not necessarily to scale, emphasis instead generally being placed upon illustrating aspects of the disclosure. In the following description, some aspects of the disclosure are described with reference to the following drawings, in which:

FIG. 1A shows an exemplary unmanned aerial vehicle including cameras configured to capture a spherical image of its vicinity;

FIG. 1B shows another view of an exemplary unmanned aerial vehicle including cameras configured to capture a spherical image of its vicinity;

FIG. 2A shows an exemplary view of an unmanned aerial vehicle controlling device;

FIG. 2B shows a detailed view of the head mounted device of the unmanned aerial vehicle controlling device;

FIG. 3 shows an exemplary flow diagram of a method for controlling an unmanned aerial vehicle, according to some aspects;

### DESCRIPTION

The following detailed description refers to the accompanying drawings that show, by way of illustration, specific details and aspects in which the disclosure may be practiced. These aspects are described in sufficient detail to enable those skilled in the art to practice the disclosure. Other aspects may be utilized and structural, logical, and electrical changes may be made without departing from the scope of the disclosure. The various aspects are not necessarily mutually exclusive, as some aspects can be combined with one or more other aspects to form new aspects. Various aspects are described in connection with methods and various aspects are described in connection with devices. However, it may be understood that aspects described in connection with methods may similarly apply to the devices, and vice versa.

The word “exemplary” is used herein to mean “serving as an example, instance, or illustration”. Any aspect or design described herein as “exemplary” is not necessarily to be construed as preferred or advantageous over other aspects or designs.

The terms “at least one” and “one or more” may be understood to include a numerical quantity greater than or equal to one (e.g., one, two, three, four, [ . . . ], etc.). The term “a plurality” may be understood to include a numerical quantity greater than or equal to two (e.g., two, three, four, five, [ . . . ], etc.).

The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of listed elements.

The words “plural” and “multiple” in the description and the claims expressly refer to a quantity greater than one. Accordingly, any phrases explicitly invoking the aforementioned words (e.g., “a plurality of [objects],” “multiple [objects]”) referring to a quantity of objects expressly refers to more than one of the said objects. The terms “group (of),” “set [of],” “collection (of),” “series (of),” “sequence (of),” “grouping (of),” etc., and the like in the description and in the claims, if any, refer to a quantity equal to or greater than one, i.e. one or more.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term data, however, is not limited to the aforementioned examples and may take various forms and represent any information as understood in the art.

The term “handle” or “handling” as for example used herein referring to data handling, file handling or request handling may be understood as any kind of operation, e.g., an I/O operation, and/or any kind of logic operation. An I/O operation may include, for example, storing (also referred to as writing) and reading.

Differences between software and hardware implemented data handling may blur. A processor, controller, and/or circuit detailed herein may be implemented in software, hardware and/or as hybrid implementation including software and hardware.

The term “processor” as, for example, used herein may be understood as any kind of entity that allows handling data. The data may be handled according to one or more specific functions executed by the processor or controller. Further, a processor or controller as used herein may be understood as any kind of circuit, e.g., any kind of analog or digital circuit.

A processor may thus be or include an analog circuit, digital circuit, mixed-signal circuit, logic circuit, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “system” (e.g., a computing system, a memory system, a storage system, etc.) detailed herein may be understood as a set of interacting elements, wherein the elements can be, by way of example and not of limitation, one or more mechanical components, one or more electrical components, one or more instructions (e.g., encoded in storage media), and/or one or more processors, and the like.

The term “mechanism” (e.g., a spring mechanism, etc.) detailed herein may be understood as a set of interacting elements, wherein the elements can be, by way of example and not of limitation, one or more mechanical components, one or more electrical components, one or more instructions, etc.

A “circuit” as user herein is understood as any kind of logic-implementing entity, which may include special-purpose hardware or a processor executing software. A circuit may thus be an analog circuit, digital circuit, mixed-signal circuit, logic circuit, processor, microprocessor, Central Processing Unit (“CPU”), Graphics Processing Unit (“GPU”), Digital Signal Processor (“DSP”), Field Programmable Gate Array (“FPGA”), integrated circuit, Application Specific Integrated Circuit (“ASIC”), etc., or any combination thereof. Any other kind of implementation of the respective functions which will be described below in further detail may also be understood as a “circuit.” It is understood that any two (or more) of the circuits detailed herein may be realized as a single circuit with substantially equivalent functionality, and conversely that any single circuit detailed herein may be realized as two (or more) separate circuits with substantially equivalent functionality. Additionally, references to a “circuit” may refer to two or more circuits that collectively form a single circuit.

As used herein, the term “memory”, “memory device”, and the like may be understood as a non-transitory computer-readable medium in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, etc., or any combination thereof. Furthermore, it is appreciated that registers, shift registers, processor registers, data buffers, etc., are also embraced herein by the term memory. It is appreciated that a single component referred to as “memory” or “a memory” may be composed of more than one different type of memory, and thus may refer to a collective component including one or more types of memory. It is readily understood that any single memory component may be separated into multiple collectively equivalent memory components, and vice versa. Furthermore, while memory may be depicted as separate from one or more other components (such as in the drawings), it is understood that memory may be integrated within another component, such as on a common integrated chip.

The term “position” used with regard to a “position of an unmanned aerial vehicle”, “position of an object”, “position of an obstacle”, and the like, may be used herein to mean a point or region in a two- or three-dimensional space. It is understood that suitable coordinate systems with respective reference points are used to describe positions, vectors, movements, and the like.

According to various aspects, information (e.g., vector data) may be handled (e.g., processed, analyzed, stored, etc.) in any suitable form, e.g., data may represent the information and may be handled via a computing system.

The term “map” used with regards to a two- or three-dimensional map may include any suitable way of describing positions of objects in the two- or three-dimensional space. According to various aspects, a voxel map may be used to describe objects in the three dimensional space based on voxels associated with objects. To prevent collision based on a voxel map, ray-tracing, ray-casting, rasterization, etc., may be applied to the voxel data.

According to various aspects, a voxel map may be used to describe objects in the three dimensional space based on voxels associated with objects. To prevent collision based on a voxel map, ray-tracing, ray-casting, rasterization, etc., may be applied to the voxel data.

An unmanned aerial vehicle (UAV) is an aircraft that has the capability of autonomous flight. In autonomous flight, a human pilot is not aboard and in control of the unmanned aerial vehicle. The unmanned aerial vehicle may also be denoted as unstaffed, uninhabited or unpiloted aerial vehicle, -aircraft or -aircraft system or UAV.

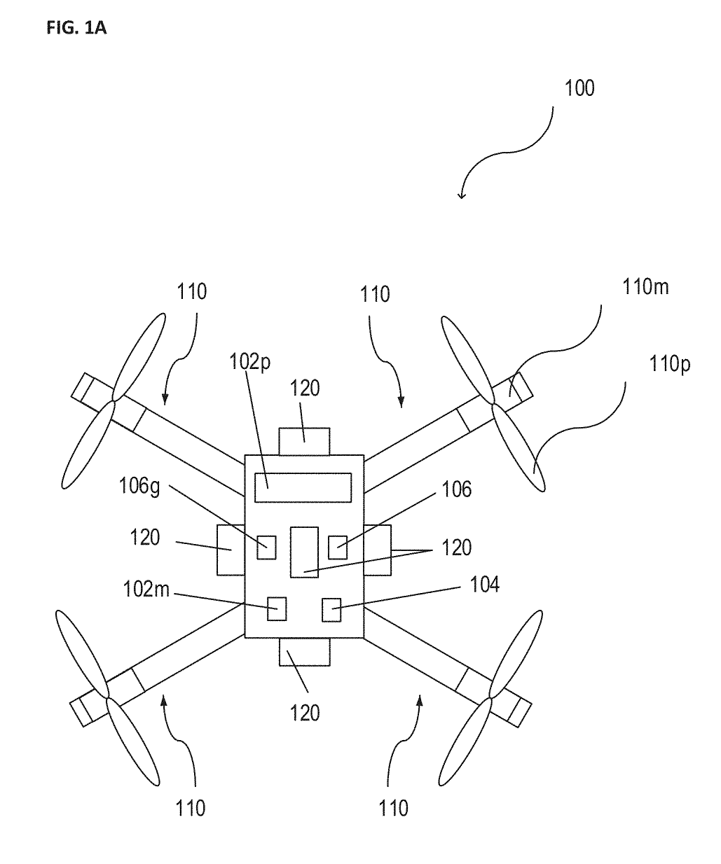

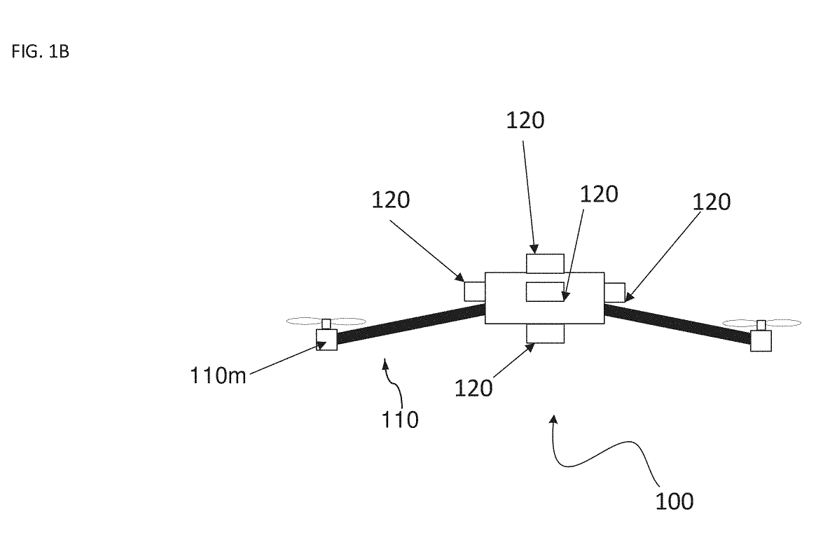

FIGS. 1A and 1B illustrate an unmanned aerial vehicle (UAV) 100 in schematic view, according to various aspects. The unmanned aerial vehicle 100 may include a plurality of (e.g., three or more than three, e.g., four, six, eight, etc.) vehicle drive arrangements 110. Each of the vehicle drive arrangements 110 may include at least one drive motor 110m and at least one propeller 110p coupled to the at least one drive motor 110m. The one or more drive motors 110m of the unmanned aerial vehicle 100 may be electric drive motors. The unmanned aerial vehicle 100 may include a plurality of cameras 120 configured to capture images of the vicinity of the unmanned aerial vehicle 100. The images may be still images of the vicinity of unmanned aerial vehicle 100 or video of the vicinity of unmanned aerial vehicle 100. Together, the images capture a 360×180 degrees view of the vicinity of unmanned aerial vehicle 100.

Additionally, the unmanned aerial vehicle 100 may include one or more processors 102p. The one or more processors 120p may be configured to combine the images captured by the plurality of cameras 120 into a spherical image of the vicinity of the unmanned aerial vehicle 100. The spherical image allows for seamless viewing in of the vicinity of the unmanned aerial vehicle.

In some instances the plurality of cameras 120 may not be able to capture the full 360×180 degrees view of the vicinity of unmanned aerial vehicle 100. For example, the plurality of cameras 120 may only capture 360×160 degrees of the vicinity of unmanned aerial vehicle 100. In such a case, the spherical image generated from the captured images may include missing spots where the plurality of cameras 120 do not perfectly capture the field of view.

Further, the one or more processors 102p may be configured to control flight or any other operation of the unmanned aerial vehicle 100 including but not limited to navigation, image analysis, location calculation, and any method or action described herein. One or more of the processors 102p may be part of a flight controller or may implement a flight controller. The one or more processors 102p may be configured, for example, to provide a flight path based at least on an actual position of the unmanned aerial vehicle 100 and a desired target position for the unmanned aerial vehicle 100. In some aspects, the one or more processors 102p may control the unmanned aerial vehicle 100. In some aspects, the one or more processors 102p may directly control the drive motors 110m of the unmanned aerial vehicle 100, so that in this case no additional motor controller may be used. Alternatively, the one or more processors 102p may control the drive motors 110m of the unmanned aerial vehicle 100 via one or more additional motor controllers. The one or more processors 102p may include or may implement any type of controller suitable for controlling the desired functions of the unmanned aerial vehicle 100. The one or more processors 102p may be implemented by any kind of one or more logic circuits.

According to various aspects, the unmanned aerial vehicle 100 may include one or more memories 102m. The one or more memories may be implemented by any kind of one or more electronic storing entities, e.g. a one or more volatile memories and/or one or more non-volatile memories. The one or more memories 102m may be used, e.g., in interaction with the one or more processors 102p, to build and/or store image data, ideal locations, locational calculations, or alignment instructions.

Further, the unmanned aerial vehicle 100 may include one or more power supplies 104. The one or more power supplies 104 may include any suitable type of power supply, e.g., a directed current (DC) power supply. A DC power supply may include one or more batteries (e.g., one or more rechargeable batteries), etc.

According to various aspects, the unmanned aerial vehicle 100 may include one or more depth sensors 106. The one or more depth sensors 106 may be configured to monitor a surrounding environment of the unmanned aerial vehicle 100, including that of a satellite unmanned aerial vehicle. The one or more depth sensors 106 may be configured to detect obstacles in the surrounding environment. The one or more depth sensors 106 may include, for example, one or more cameras (e.g., a depth camera, a stereo camera, a thermal imaging camera, etc.), one or more ultrasonic sensors, etc. The unmanned aerial vehicle 100 may further include a position detection system 106g. The position detection system 106g may be based, for example, on Global Positioning System (GPS) or any other available positioning system. Therefore, the one or more processors 102p may be further configured to modify the flight path of the unmanned aerial vehicle 100 based on data obtained from the position detection system 106g. The depth sensors 106 may be mounted as depicted herein, or in any other configuration suitable for an implementation.

According to various aspects, the one or more processors 102p may include at least one transceiver configured to provide an uplink transmission and/or downlink reception of radio signals including data, e.g. video or image data and/or commands. The at least one transceiver may include a radio frequency (RF) transmitter and/or a radio frequency (RF) receiver.

Additionally, the transceiver may be configured to receive a control signal from an unmanned aerial vehicle controlling device 200 (described below). The one or more processors 102p may control flight of unmanned aerial vehicle 100 according to the control signal received from unmanned aerial vehicle controlling device 200.

The one or more processors 102p may further include an inertial measurement circuit (IMU) and/or a compass circuit. The inertial measurement circuit may allow, for example, a calibration of the unmanned aerial vehicle 100 regarding a predefined plane in a coordinate system, e.g., to determine the roll and pitch angle of the unmanned aerial vehicle 100 with respect to the gravity vector (e.g. from planet earth). Thus, the one or more processors 102p may be configured to determine an orientation of the unmanned aerial vehicle 100 in a coordinate system. The orientation of the unmanned aerial vehicle 100 may be calibrated using the inertial measurement circuit before the unmanned aerial vehicle 100 is operated in flight modus. However, any other suitable function for navigation of the unmanned aerial vehicle 100, e.g., for determining a position, a flight velocity, a flight direction, etc., may be implemented in the one or more processors 102p and/or in additional components coupled to the one or more processors 102p. Further, the one or more cameras 120 may be configured to photograph an object of interest. The camera 120 may be a still photo camera 120, e.g. a depth camera. However, any other suitable or desired camera may be used in alternative configurations.

FIG. 1B illustrates a side view of unmanned aerial vehicle 100 including a plurality of cameras 120 which can capture images of the vicinity of unmanned aerial vehicle 100. As stated previously, UAV 100 may operate in a suitable coordinate system with respective reference points used to describe map sensed movements. For example, the axes are used to map tracked movements within tracked space 201 (described below) to movements for the unmanned aerial vehicle. Normally, these axes are represented by the letters X, Y and Z in order to compare them with some reference. For example, the X, Y, and Z axes of the tracked space 201.

The Y-Axis, also referred to as the normal axis, vertical axis, or yaw axis, is an axis drawn from the top to bottom and is used to describe vertical movement. Movement in the Y direction may be described as positive and negative. Movements in the positive Y direction are associated with moving up and movements in the negative Y direction are associated with moving down.

The X-Axis, also referred to as the transverse axis, lateral axis, or pitch axis, is an axis running from the left to right of the unmanned aerial vehicle. Movement in the X direction may be described as positive and negative. Movements in the positive X direction may be associated with moving left and movements in the negative X direction may be associated with moving right.

The Z-Axis, also referred to as the longitudinal axis, or roll axis, is drawn through the body of the unmanned aerial vehicle from front to back. Movement in the Z direction may be described as positive and negative. Movements in the positive Z direction may be associated with moving forward and movements in the negative Z direction may be associated with moving backward.

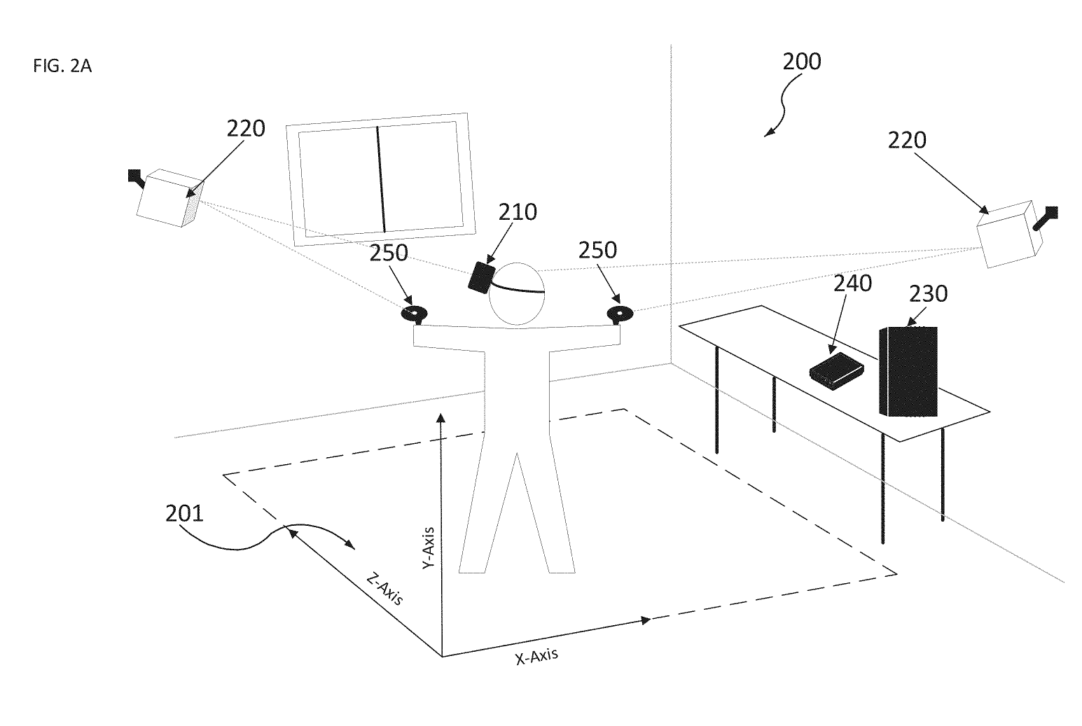

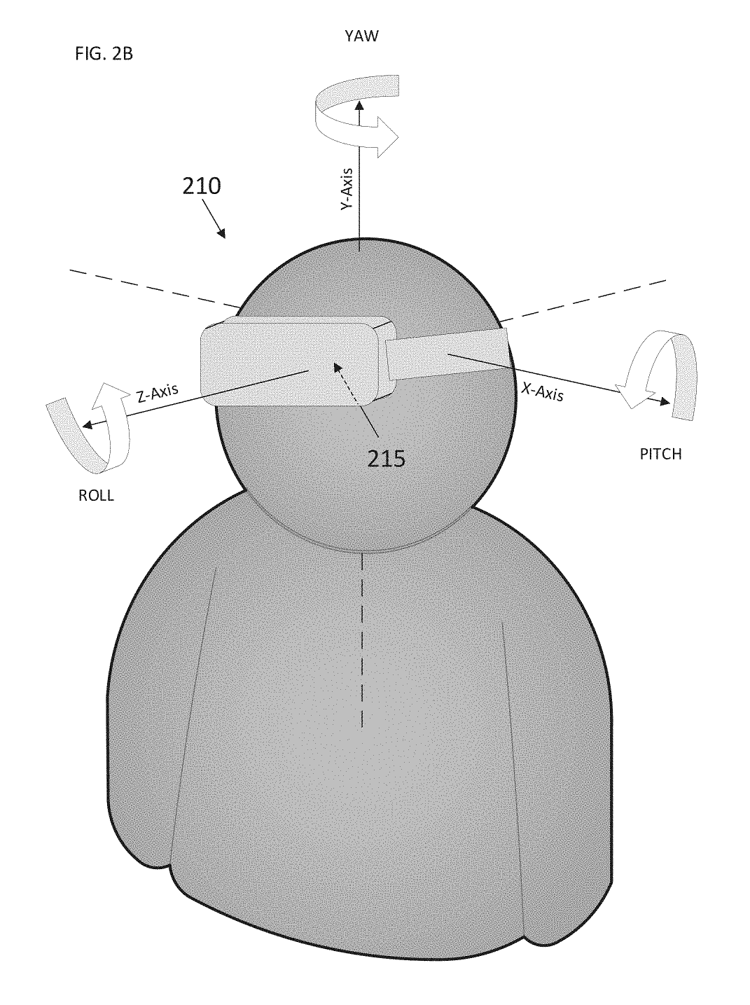

FIG. 2A illustrates an unmanned aerial vehicle controlling device 200 in schematic view, according to various aspects. The unmanned aerial vehicle controlling device 200 may be configured to monitor a tracked space 201. Unmanned aerial vehicle controlling device 200 may include a head mounted device 210. Head mounted device 210 may include display 215 (not displayed) configured to display a field of view of a spherical image. The field of view will change based on the direction in which the head mounted device is pointed. Motions sensors 220 may detect the direction in which head mounted device 210 is pointing and one or more processors 230 may be configured to process the detected direction to choose a field of view of a spherical image based on the detected direction. Additionally, one or more motion sensors 220 may be configured to track movement of the head mounted device 210 within tracked space 201. One or more processors 230 may be configured to map the tracked movement of head mounted device in the tracked space to the vicinity of the unmanned aerial vehicle using an XYZ coordinate system. For example, XYZ coordinates in the tracked space 201 can be mapped to the XYZ coordinates of the vicinity of the unmanned aerial vehicle 100. The unmanned aerial vehicle controlling device 200 may include a transceiver 240 to receive a spherical image of a vicinity of an unmanned aerial vehicle. Display 215 may display a field of view based on the direction the head mounted device 210 is facing.

For example, unmanned aerial vehicle controlling device 200 may be set up to monitor an area of 3×3 meters in the center of a room. The 3×3 meters of monitored space in the center of a room may be the tracked space 201. If motion sensors 220 detect that the head mounted device 210 has rotated, the one or more processors 230 will map that movement to change the field of view of display 215. Rotation of the head mounted device 210 will only affect the field of view of display 215 and not affect movement of the unmanned aerial vehicle 100.

For example, if the head mounted device 210 is facing in the positive Z direction and is rotated 90 degrees to face in the positive X direction the one or more processors 230 will change the field of view on display 215 based on the detected rotation of head mounted device 210. The field of view will change from the positive Z direction of the spherical image of unmanned aerial vehicle 100 to the positive X direction of the spherical image of unmanned aerial vehicle 100. The change in the field of view will not affect movement of the unmanned aerial vehicle 100.

Movement in the positive Z direction of the tracked space translates to generating and transmitting a control signal to unmanned aerial vehicle 100 to move unmanned aerial vehicle 100 in its positive Z direction. For example, if motion sensors 220 track that the head mounted device 210 moves 1 meter forward in the positive Z direction, that movement may be mapped to a movement of the unmanned aerial vehicle 100 1 meter in its positive Z direction. One or more processors 230 may generate a control signal based on the mapped movement and transmit the control signal using transceiver 240 to unmanned aerial vehicle 100. UAV 100 may execute the control signal to control its flight to move 1 meter in its positive Z direction. Mapping movements may be done by comparing the Z axis within the tracked space 201 to the Z axis in the coordinate system of unmanned aerial vehicle 100.

Alternatively, movements may be mapped with a scale. For example, movements in the positive or negative Y direction may be scaled in a 1:10 scale so that a 1 cm movement of the head mounted device 210 in the negative Y direction will be used to generate a control signal to move the unmanned aerial vehicle 10 cm in the UAV's negative Y direction.

Movements based on mapped movements, as previously described, are also referred to micro-level movements of the unmanned aerial vehicle. These are intended to control the unmanned aerial vehicle with precision. Additionally, the unmanned aerial vehicle controlling device 200 may also include one or more joysticks 250 to control the unmanned aerial vehicle 100 for larger, or macro-level, movements that do not require precision. Joysticks can be used to control flight of the unmanned aerial vehicle without having to track movement of the head mounted device. This allows control of the unmanned aerial vehicle over distances that are greater than those that can be mapped from the tracked space. Alternatively, a gamepad may be used to control macro-level movements of UAV 100. One or more processors may use the joystick or gamepad controls to generate and transmit, via transceiver 240, a control signal based on the macro-level movements.

FIG. 2B illustrates a more detailed view of the head mounted device 210. Head mounted device 210 includes display 215 configured to display a field of view corresponding to the first person view of the spherical image of the vicinity of unmanned aerial vehicle 100.

For example, if the head mounted device rotates about the Y-Axis or yaw, the field of view displayed on display 215 may change from the forward field of view to the left field of view of the unmanned aerial vehicle.

As another example if the head mounted device rotates about the X-Axis or pitch it can change the field of view displayed on display 215 from the front to the field of view above or below the UAV. For example, if the UAV is being used to inspect the underneath of a target object, the UAV may be positioned under the target object using macro-level or micro-level movements, as described above, to position the UAV underneath the target object. Once in the desired position, the head mounted device may be rotated about the X-Axis to change the field of view to display a field of view of the underneath of the target object which is above the unmanned aerial vehicle.

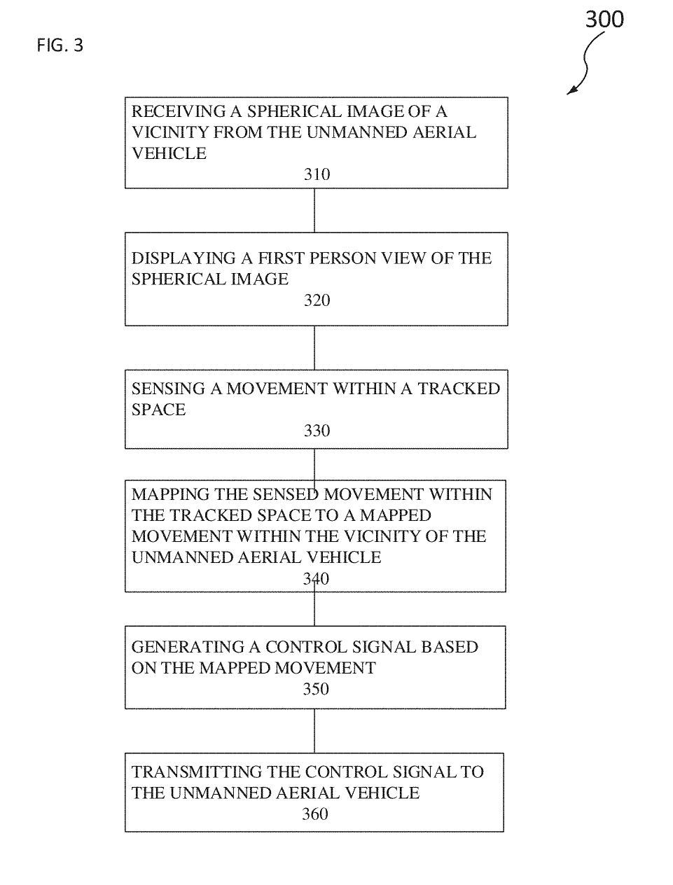

FIG. 3 illustrates a schematic flow diagram of exemplary method 300 for controlling an unmanned aerial vehicle. The method may include: in 310 receiving a spherical image of a vicinity from the unmanned aerial vehicle; in 320 displaying a first person view of the spherical image; in 330 sensing a movement within a tracked space; in 340 mapping the sensed movement within the tracked space to a mapped movement within the vicinity of the unmanned aerial vehicle; in 350 generating a control signal based on the mapped movement; and in 360 transmitting the control signal to the unmanned aerial vehicle.

The unmanned aerial vehicle controlling device may include a Virtual Reality (VR) head mounted display in combination with positional tracking to control an unmanned aerial vehicle according to the motion of the controlling device. The unmanned aerial vehicle can be controlled by moving it relative to the tracked the position of the controlling device. Advanced steering of the UAV can be done by mimicking the movements of the controlling device. Additionally, the described techniques are also applicable using Augmented Reality (AR) or Mixed Reality (MR) head mounted devices.

The UAV is equipped with cameras configured to capture a complete image of the vicinity. The images can be stitched together to create a spherical image. For example, an UAV may be equipped with 6 cameras. The UAV may be configured to at least move front, back, left, right, up, or down within its coordinate system.

Having a plurality of cameras able to capture images or video of the vicinity of the UAV and processors to generate a spherical image based on the captured images, allows the controlling device to seamlessly display all directions of the vicinity of the UAV without the need to control the UAV to move. For example, the field of view displayed within a head mounted device may change based on rotation of the head mounted device.

Accordingly, roll, pitch, and yaw movements of the head mounted device of the unmanned aerial vehicle controlling device will translate into displaying a different field of view of the visual sphere. This does not required rolling, pitching, and yawing the UAV itself. This feature is referred to as a virtual gimbal.

The ability to display the vicinity of the UAV in all directions and precisely control the UAV using mapped movements may be useful for inspecting target objects.

The UAV is equipped with feature of holding a stable position. Using inertial measurement units and gyroscopes, the UAV will try to hold a steady position from which it does not move. Additionally, this means that the roll and pitch angle will be maintained in a way that keeps the UAV steady. If there is no wind, the UAV will be aligned perpendicular to the ground.

An exemplary unmanned aerial vehicle controlling device includes a head mounted device (HMD), such as a virtual reality head mounted device. The position and orientation of the HMD will be tracked within the tracked space of the controlling device. The HMD will display a field of view of the spherical image of the vicinity of the UAV. The field of view will be from the perspective of the UAV and mapped to the HMDs position within the tracked space.

The tracked space will be a predefined area. Movements within that area will be translated or mapped to the UAV.

For example if the UAV has an XYZ coordinate system and the HMD has an XYZ coordinate system movements of the HMD within its tracked space can be mapped to the XYZ coordinate system of the UAV. The UAV can be controlled by the mapped movements to mimic the movements of the HMD within its tracked space to an XYZ coordinate system of the UAV.

The field of view is determined by the orientation of the HMD. Based on the orientation, the Z axis is defined as the forward vector and can be mapped to the UAV. As the orientation of the HMD changes, the Z axis for both the HMD and the UAV may be redefined so that the Z axis of the UAV points in the same direction as the orientation of the HMD.

By mapping movements of an HMD within a tracked space to a UAV, a pilot may easily control a UAV to make careful and precise movements. For example, a pilot can control a UAV to get within 50 cm, 40 cm, 30 cm, etc. to a wall. For example, to inspect a wall. Using room-scale virtual reality, the HMDs position is tracked within the tracked space and mapped to the space of the UAV. This is known as Micro-level steering. Mapping the movements of the HMD in its tracked space translate to relative movements of the UAV within its real space.

For example, a slow movement of the HMD within its tracked space may translate to slowly controlling the UAV to approach an obstacle (visible in the field of view of the display of the HMD) for inspection.

The HMD movements in the positive and negative Y axis may be scaled. For example, movements in the Y axis of the tracked space may be limited to small movements as compared to movements in the Z and X axes. An example scale may be that for every 1 cm of movement in the Y axis of the tracked space the mapped movement to control the UAV would be 10 cm.

Tracking and sensing the movement of a controlling device allows for accurate control of a UAV. The controlling device can be moved within the tracked space to change the displayed view. For example, the direction in which the HMD device is pointed can be mapped to the view of the vicinity of the UAV. For example, if the controlling device is pointed in the positive X direction it will display a field of view the vicinity of the UAV in the positive X direction. If the controlling device is turned 90 degrees, it may change the field of view to the vicinity of the UAV in the positive Z direction.

Controlling the UAV is accomplished by monitoring movement of the controlling device. The unmanned aerial vehicle controlling device may move in the positive Z direction within the tracked space. Such a movement will be mapped to the vicinity of the UAV, and control the UAV to move in its respective positive Z direction.

Alternatively, the controlling device may be moved in the negative Z direction within the tracked space. Such a movement may continue to display a view of the vicinity of the UAV in the positive Z direction, but control the UAV to move in the negative Z direction. For example, if the UAV is being used to inspect an object and is too close to the object to inspect the necessary area, it may need to back up.

Controlling the UAV for larger movements may be done using macro-level steering. Instead of controlling the UAV with mapped movements within the tracked space, larger movement may be controlled using a joystick.

For large movements of the UAV, joystick or gamepad controls may be used to control the UAV without requiring that the unmanned aerial vehicle controlling device to physically move. Once the UAV is close to its desired position using macro-level steering, it can be controlled using micro-level steering to maneuver the UAV with more precision.

Macro-level steering may be combined with micro-level steering. For example, a gamepad control can be used to control the UAV to move forward over several 100 meters. If the macro-level movement needs to be slightly adjusted, the head mounted device can slightly shift to one side. In this way, the several 100 meters flight path of the unmanned aerial vehicle will may be slightly adjusted as it is executing its several 100 meters flight path.

Combining macro-level and micro-level movements may be beneficial for maneuvering an unmanned aerial vehicle through an obstacle course.

Additionally, the controlling device may be configured to switch between macro-level steering and micro-level steering. For example, macro-level steering might be used to control the UAV to get it within a few meters of an object. Then the controlling device can switch to micro-level steering to carefully move the UAV to within centimeters of an object identified for inspection.

Macro-level movements of the UAV may be controlled using a joystick or gamepad without requiring the controlling device to move within the tracked space.

The field of view displayed during macro-level steering may be adjusted. For example if a user is viewing the display through a HMD the field of view may be narrowed to avoid motion sickness.

Additionally, the UAV may be equipped with obstacle avoidance technology. If mapping a movement in the tracked space would result in collision of the UAV with an obstacle, the UAV will not follow the command based on the mapped movement. A delay may be set up between the UAV controlling devices movement and mapping them to the UAV so that the controlling device can be alerted to an obstacle within the UAVs vicinity and take an appropriate action.

For example the display within the controlling device may black out to alert a pilot that the movement would translate to controlling the UAV into an obstacle.

In the following, various examples are provided with reference to the aspects described above.

Example 1 is an unmanned aerial vehicle controlling device. The unmanned aerial vehicle controlling device includes a receiver configured to receive a spherical image of a vicinity from an unmanned aerial vehicle; a display configured to display a first person view of the spherical image; a plurality of motion sensors configured to sense a movement within a tracked space; one or more processors configured to map the sensed movement within the tracked space to a mapped movement within the vicinity of the unmanned aerial vehicle and generate a control signal based on the mapped movement; and a transmitter configured to transmit the control signal to the unmanned aerial vehicle;

In Example 2, the subject matter of Example 1 can optionally include a head mounted device wherein the head mounted device houses the display.

In Example 3, the subject matter of Example 2 can optionally include that the motion sensors are further configured to track a movement of the head mounted device within the tracked space.

In Example 4, the subject matter of Examples 1-3 can optionally include that the mapped movement is the same distance as the sensed movement.

In Example 5, the subject matter of Examples 1-3 can optionally include that the mapped movement is a greater distance than the sensed movement.

In Example 6, the subject matter of Examples 1-5 can optionally include a joystick. The one or more processors generate a macro control signal based on a joystick control.

In Example 7, the subject matter of Examples 1-5 can optionally include a gamepad. The one or more processors generate a macro control signal based on a gamepad control.

In Example 8, the subject matter of Examples 6-7 can optionally include that the control signal based on the mapped movement overrides the macro control signal.

In Example 9, the subject matter of Examples 6-7 can optionally include that the macro control signal overrides the control signal based on the mapped movement.

In Example 10, the subject matter of Examples 6-7 can optionally include that the control signal based on the mapped movement the macro control signal are executed simultaneously.

In Example 11, the subject matter of Examples 1-10 can optionally include that there is a latency between generating the control signal and transmitting the control signal.

In Example 12, the subject matter of Examples 1-11 can optionally include that the unmanned aerial vehicle controlling device is further configured to detect the head mounted device is approaching a boundary of the tracked space.

In Example 13, the subject matter of Example 12 can optionally include that that the unmanned aerial vehicle controlling device is further configured to generate an alert that the head mounted device approached the boundary.

In Example 14, the subject matter of Examples 1-13 can optionally include that the unmanned aerial vehicle controlling device is further configured to detect the head mounted device moved outside of a boundary of the tracked space.

In Example 15, the subject matter of Example 14 can optionally include that the unmanned aerial vehicle controlling device is further configured to generate an alert that the head mounted device moved outside of a boundary of the tracked space.

Example 16 is an unmanned aerial vehicle. The unmanned aerial vehicle includes a plurality of cameras configured to capture a plurality of images of a vicinity of the unmanned aerial vehicle; one or more processors configured to combine the plurality of images into a spherical image; a transceiver; and one or more processors configured to control the unmanned aerial vehicle according to the control signal based on a mapped movement. The transceiver is configured transmit the spherical image to an unmanned aerial vehicle controlling device; and receive a control signal based on a mapped movement from the unmanned aerial vehicle controlling device.

In Example 17, the subject matter of Example 16 can optionally include that the plurality of cameras are further configured to detect an obstacle in a path of the unmanned aerial vehicle.

In Example 18, the subject matter of Example 17 can optionally include that the transceiver is further configured to transmit an alert signal to the unmanned aerial vehicle controlling device upon the detection of the obstacle in the path of the unmanned aerial vehicle.

In Example 19, the subject matter of Example 18 can optionally include that the one or more processors are further configured to control the unmanned aerial vehicle to avoid the obstacle.

In Example 20, the subject matter of Examples 16-19 can optionally include that the one or more processors are further configured to delay execution of the received control signal.

Example 21 is a system for controlling an unmanned aerial vehicle having an unmanned aerial vehicle controlling device. The unmanned aerial vehicle controlling device includes a receiver configured to receive a spherical image of a vicinity from an unmanned aerial vehicle; a display configured to display a first person view of the spherical image; a plurality of motion sensors configured to sense a movement within a tracked space; one or more processors configured to map the sensed movement within the tracked space to a mapped movement within the vicinity of the unmanned aerial vehicle and generate a control signal based on the mapped movement; and a transmitter configured to transmit the control signal to the unmanned aerial vehicle;

In Example 22, the subject matter of Example 21 can optionally include a head mounted device wherein the head mounted device houses the display.

In Example 23, the subject matter of Example 22 can optionally include that the motion sensors are further configured to track a movement of the head mounted device within the tracked space.

In Example 24, the subject matter of Examples 21-23 can optionally include that the mapped movement is the same distance as the sensed movement.

In Example 25, the subject matter of Examples 21-23 can optionally include that the mapped movement is a greater distance than the sensed movement.

In Example 26, the subject matter of Examples 21-25 can optionally include a joystick. The one or more processors generate a macro control signal based on a joystick control.

In Example 27, the subject matter of Examples 21-25 can optionally include a gamepad. The one or more processors generate a macro control signal based on a gamepad control.

In Example 28, the subject matter of Examples 26-27 can optionally include that the control signal based on the mapped movement overrides the macro control signal.

In Example 29, the subject matter of Examples 26-27 can optionally include that the macro control signal overrides the control signal based on the mapped movement.

In Example 30, the subject matter of Examples 26-27 can optionally include that the control signal based on the mapped movement the macro control signal are executed simultaneously.

In Example 31, the subject matter of Examples 21-30 can optionally include that there is a latency between generating the control signal and transmitting the control signal.

In Example 32, the subject matter of Examples 21-31 can optionally include that the unmanned aerial vehicle controlling device is further configured to detect the head mounted device is approaching a boundary of the tracked space.

In Example 33, the subject matter of Example 32 can optionally include that that the unmanned aerial vehicle controlling device is further configured to generate an alert that the head mounted device approached the boundary.

In Example 34, the subject matter of Examples 1-13 can optionally include that the unmanned aerial vehicle controlling device is further configured to detect the head mounted device moved outside of a boundary of the tracked space.

In Example 35, the subject matter of Example 34 can optionally include that the unmanned aerial vehicle controlling device is further configured to generate an alert that the head mounted device moved outside of a boundary of the tracked space.

Example 36 is an unmanned aerial vehicle. The unmanned aerial vehicle includes a plurality of cameras configured to capture a plurality of images of a vicinity of the unmanned aerial vehicle; one or more processors configured to combine the plurality of images into a spherical image; a transceiver; and one or more processors configured to control the unmanned aerial vehicle according to the control signal based on a mapped movement. The transceiver is configured transmit the spherical image to an unmanned aerial vehicle controlling device; and receive a control signal based on a mapped movement from the unmanned aerial vehicle controlling device.

In Example 37, the subject matter of Example 36 can optionally include that the plurality of cameras are further configured to detect an obstacle in a path of the unmanned aerial vehicle.

In Example 38, the subject matter of Example 37 can optionally include that the transceiver is further configured to transmit an alert signal to the unmanned aerial vehicle controlling device upon the detection of the obstacle in the path of the unmanned aerial vehicle.

In Example 39, the subject matter of Example 38 can optionally include that the one or more processors are further configured to control the unmanned aerial vehicle to avoid the obstacle.

In Example 40, the subject matter of Examples 36-39 can optionally include that the one or more processors are further configured to delay execution of the received control signal.

Example 41 is an unmanned aerial vehicle controlling device. The unmanned aerial vehicle controlling device having means to receive a spherical image of a vicinity from an unmanned aerial vehicle; display a first person view of the spherical image; sense a movement within a tracked space; map the sensed movement within the tracked space to a mapped movement within the vicinity of the unmanned aerial vehicle and generate a control signal based on the mapped movement; transmit the control signal to the unmanned aerial vehicle;

In Example 42, the subject matter of Example 41 can optionally include means to house the display in a head mounted device.

In Example 43, the subject matter of Example 42 can optionally include means to track a movement of the head mounted device within the tracked space.

In Example 44, the subject matter of Examples 41-43 can optionally include means to map movement of the same distance as the sensed movement.

In Example 45, the subject matter of Examples 41-43 can optionally include means to map movement of a greater distance than the sensed movement.

In Example 46, the subject matter of Examples 41-45 can optionally include means to generate a macro control signal based on a joystick control.

In Example 47, the subject matter of Examples 41-45 can optionally include means to generate a macro control signal based on a gamepad control.

In Example 48, the subject matter of Examples 46-47 can optionally include means to override the mapped movement with the macro control signal.

In Example 49, the subject matter of Examples 46-47 can optionally include means to override the macro control signal with the mapped movement.

In Example 50, the subject matter of Examples 46-47 can optionally include means to simultaneously execute the macro control signal and the control signal including the mapped movement.

In Example 51, the subject matter of Examples 41-50 can optionally include means to delay transmitting the control signal after generating the control signal.

In Example 52, the subject matter of Examples 41-51 can optionally include means to detect the head mounted device is approaching a boundary of the tracked space.

In Example 53, the subject matter of Example 52 can optionally include means to generate an alert that the head mounted device approached the boundary.

In Example 54, the subject matter of Examples 41-53 can optionally include means to detect the head mounted device moved outside of a boundary of the tracked space.

In Example 55, the subject matter of Example 54 can optionally include that means to generate an alert that the head mounted device moved outside of a boundary of the tracked space.

Example 56 is an unmanned aerial vehicle device. The unmanned aerial vehicle having means capture a plurality of images of a vicinity of the unmanned aerial vehicle; combine the plurality of images into a spherical image; control the unmanned aerial vehicle according to the control signal based on a mapped movement; transmit the spherical image to an unmanned aerial vehicle controlling device; receive a control signal based on a mapped movement from the unmanned aerial vehicle controlling device.

In Example 57, the subject matter of Example 56 can optionally include means to detect an obstacle in a path of the unmanned aerial vehicle.

In Example 58, the subject matter of Example 57 can optionally include means transmit an alert signal to the unmanned aerial vehicle controlling device upon the detection of the obstacle in the path of the unmanned aerial vehicle.

In Example 59, the subject matter of Example 58 can optionally include means to control the unmanned aerial vehicle to avoid the obstacle.

In Example 60, the subject matter of Examples 56-59 can optionally means to delay execution of the received control signal.

Example 61 is a method for controlling an unmanned aerial vehicle including receiving a spherical image of a vicinity from an unmanned aerial vehicle; displaying a first person view of the spherical image; sensing a movement within a tracked space; mapping the sensed movement within the tracked space to a mapped movement within the vicinity of the unmanned aerial vehicle and generating a control signal based on the mapped movement; transmitting the control signal to the unmanned aerial vehicle;

In Example 62, the subject matter of Example 61 can optionally include displaying a field of view within a head mounted device.

In Example 63, the subject matter of Example 62 can optionally tracking a movement of the head mounted device within the tracked space.

In Example 64, the subject matter of Examples 61-63 can optionally include mapping movement of the same distance as the sensed movement.

In Example 65, the subject matter of Examples 61-63 can optionally include mapping movement of a greater distance than the sensed movement.

In Example 66, the subject matter of Examples 61-65 can optionally include generating a macro control signal based on a joystick control.

In Example 67, the subject matter of Examples 61-65 can optionally include generating a macro control signal based on a gamepad control.

In Example 68, the subject matter of Examples 66-67 can optionally include overriding the macro control signal with the mapped movement.

In Example 69, the subject matter of Examples 66-67 can optionally include overriding the control signal based on the mapped movement with the macro control signal.

In Example 70, the subject matter of Examples 66-67 can optionally include simultaneously executing the control signal based on the mapped movement and the macro control signal.

In Example 71, the subject matter of Examples 61-70 can optionally include generating a latency between generating the control signal and transmitting the control signal.

In Example 72, the subject matter of Examples 61-71 can optionally include detecting the head mounted device is approaching a boundary of the tracked space.

In Example 73, the subject matter of Example 72 can optionally include generating an alert that the head mounted device approached the boundary.

In Example 74, the subject matter of Examples 61-73 can optionally include detecting the head mounted device moved outside of a boundary of the tracked space.

In Example 75, the subject matter of Example 74 can optionally include generating an alert that the head mounted device moved outside of a boundary of the tracked space.

Example 76 is a method for controlling an unmanned aerial vehicle including capturing a plurality of images of a vicinity of the unmanned aerial vehicle; combining the plurality of images into a spherical image; controlling the unmanned aerial vehicle according to the control signal based on a mapped movement; transmitting the spherical image to an unmanned aerial vehicle controlling device; and receiving a control signal based on a mapped movement from the unmanned aerial vehicle controlling device.

In Example 77, the subject matter of Example 76 can optionally include detecting an obstacle in a path of the unmanned aerial vehicle.

In Example 78, the subject matter of Example 77 can optionally include transmitting an alert signal to the unmanned aerial vehicle controlling device upon the detection of the obstacle in the path of the unmanned aerial vehicle.

In Example 79, the subject matter of Example 78 can optionally include controlling the unmanned aerial vehicle to avoid the obstacle.

In Example 80, the subject matter of Examples 76-79 can optionally include delaying execution of the received control signal.

Example 81 is a non-transitory computer readable medium storing instructions thereon that, when executed via one or more processors of a vehicle, control the vehicle to perform any of the methods of Examples 61-80.

What is claimed is:

1. An unmanned aerial vehicle controlling device comprising:
a receiver configured to receive a spherical image of a vicinity from an unmanned aerial vehicle;
a display configured to display a first person view of the spherical image;
a plurality of motion sensors configured to sense a movement within a tracked space;
one or more processors configured to map the sensed movement within the tracked space to a mapped movement within the vicinity of the unmanned aerial vehicle and generate a control signal based on the mapped movement; and
a transmitter configured to transmit the control signal to the unmanned aerial vehicle.

2. The unmanned aerial vehicle controlling device of claim 1, further comprising a head mounted device wherein the head mounted device houses the display.

3. The unmanned aerial vehicle controlling device of claim 2, wherein the motion sensors are further configured to track the movement of the head mounted device within the tracked space.

4. The unmanned aerial vehicle controlling device of claim 1, wherein the mapped movement is a greater distance than the sensed movement.

5. The unmanned aerial vehicle controlling device of claim 1 further comprising a gamepad, wherein the one or more processors generate a macro control signal based on a gamepad control.

6. The unmanned aerial vehicle controlling device of claim 5, wherein the control signal based on the mapped movement overrides the macro control signal.

7. The unmanned aerial vehicle controlling device of claim 5, wherein the macro control signal overrides the control signal based on the mapped movement.

8. The unmanned aerial vehicle controlling device of claim 5, wherein the control signal based on the mapped movement the macro control signal are executed simultaneously.

9. The unmanned aerial vehicle controlling device of claim 1, wherein there is a latency between generating the control signal and transmitting the control signal.

10. The unmanned aerial vehicle controlling device of claim 1, further configured to detect the head mounted device is approaching a boundary of the tracked space.

11. The unmanned aerial vehicle controlling device of claim 10, further configured to generate an alert that the head mounted device approached the boundary.

12. An unmanned aerial vehicle comprising:
a plurality of cameras configured to capture a plurality of images of a vicinity of the unmanned aerial vehicle;
one or more processors configured to combine the plurality of images into a spherical image;
a transceiver configured to:
transmit the spherical image to an unmanned aerial vehicle controlling device;
receive a control signal based on a mapped movement from the unmanned aerial vehicle controlling device; and
one or more processors configured to control the unmanned aerial vehicle according to the control signal based on a mapped movement.

13. The unmanned aerial vehicle of claim 12, wherein the plurality of cameras are further configured to detect an obstacle in a path of the unmanned aerial vehicle.

14. The unmanned aerial vehicle of claim 13, further configured to transmit an alert signal to the unmanned aerial vehicle controlling device upon the detection of the obstacle in the path of the unmanned aerial vehicle.

15. The unmanned aerial vehicle of claim 13, further configured to control the unmanned aerial vehicle to avoid the obstacle.

16. The unmanned aerial vehicle of claim 12, wherein the one or more processors are further configure to delay execution of the received control signal.

17. A method for controlling an unmanned aerial vehicle:
receiving a spherical image of a vicinity from the unmanned aerial vehicle;
displaying a first person view of the spherical image;
sensing a movement within a tracked space;
mapping the sensed movement within the tracked space to a mapped movement within the vicinity of the unmanned aerial vehicle;
generating a control signal based on the mapped movement; and
transmitting the control signal to the unmanned aerial vehicle.

18. The method of claim 17, further comprising displaying a field of view in a head mounted device.

19. The method of claim 18, tracking movement of the head mounted device within the tracked space.

20. The method of claim 19, mapping the sensed movement to a greater distance than the sensed movement.
